(19) United States
(12) Patent Application Publication
(10) Pub. No.: US 2026/0336983 A1
(43) Pub. Date: Oct. 29, 2026

(54) METHOD FOR MONITORING A ROTARY MOVEMENT OF A GEAR IN THE DRIVE OF AN ESCALATOR OR A MOVING WALKWAY

(71) Applicant: Inventio AG, Hergiswil (CH)

(72) Inventor: Alexander Prenner, Pöttsching (AT)

(21) Appl. No.: 19/114,615

(22) PCT Filed: Nov. 6, 2023
(86) PCT No.: PCT/EP2023/080754

§ 371 Date: Mar. 24, 2025

(30) Foreign Application Priority Data
Nov. 8, 2022 (EP) 22206026.1

(51) Int. Cl. B66B 25/00

(52) U.S. Cl. CPC B66B 25/006

(57) ABSTRACT

A method for monitoring a rotary movement of a gear in the drive of an escalator comprises: receiving a sensor signal generated using a sensor for scanning a toothing of the gear in a signal processing device; detecting pulses by scanning the sensor signal, the pulses being counted by assigning a count value to each pulse, each pulse also being assigned a time value which indicates a time interval between the pulse and the next pulse; carrying out the following steps for each detected pulse: selecting a reference time value by comparing the count value assigned to the detected pulse with a list which assigns reference time values to possible count values; determining a deviation of the time value assigned to the detected pulse from the selected reference time value; on the basis of the deviation, detecting whether the gear is rotating at a desired speed.

### TECHNICAL FIELD

The present disclosure relates to a method for monitoring a rotary movement of a gear in the drive of an escalator. Furthermore, the disclosure relates to a signal processing device, to a computer program and to a computer-readable medium for carrying out the method, as well as to a sensor device and to an escalator.

### SUMMARY

The monitoring of the rotational speed and/or the direction of rotation of a gear of an escalator, such as a sprocket of a chain drive for driving a step or pallet belt and/or a handrail of the escalator, can be carried out, for example, by means of two inductive sensors which are located opposite the toothing of the gear at different scanning points. The number of pulses available to detect the corresponding motion parameter per revolution is limited by the number of sensors. The use of more than two sensors does increase the number of pulses per revolution, e.g., the resolution of the resulting sensor signal, but on the other hand this can lead to signal irregularities which can lead to undesirable measurement inaccuracies despite the increased resolution.

There may therefore be a need for a method that enables monitoring of a rotary movement of a gear in the drive of an escalator with increased accuracy and/or increased reliability, especially when more than two sensors are used to simultaneously scan the toothing of the gear.

Furthermore, there may be a need for a corresponding signal processing device, a corresponding computer program, a corresponding computer-readable medium, a corresponding sensor device, and a corresponding escalator.

These needs can be met by the subject matter of the independent claims. Advantageous embodiments are defined in the dependent claims, in the following description and in the accompanying drawings.

A first aspect of the disclosure can relate to a method for monitoring a rotary movement of a gear in the drive of an escalator. The method can comprise the following steps: receiving a sensor signal which was generated using at least one sensor for scanning the toothing of the gear in a signal processing device; detecting pulses by scanning the sensor signal, the pulses being counted by assigning a count value to each pulse, each pulse also being assigned a time value which indicates a time interval between the pulse and the next pulse; carrying out the following steps for each detected pulse: selecting a reference time value by comparing the count value assigned to the detected pulse with a list which assigns reference time values to possible count values; determining a deviation of the time value assigned to the detected pulse from the selected reference time value; on the basis of the deviation, detecting whether the gear is rotating at a desired speed.

The method may be computer-implemented and carried out automatically by a processor, for example of the signal processing device of the escalator.

The method can make it possible to compensate for irregularities in the sensor signal, for example, due to inaccuracies in the gear and/or the sensor and/or due to the so-called polygon effect in a chain drive.

More specifically, the method can make it possible to select a separate threshold value from multiple possible threshold values for each detected pulse, e.g., for each tooth of the toothing for which a pulse was generated. In this way, geometric irregularities of the toothing and/or other possible inaccuracies, for example, in the alignment of an active surface of the sensor (detection range of the sensor) with respect to the toothing and/or to each other (e.g., due to wear and/or temperature fluctuations), can be taken into account in the monitoring, which may significantly increase the accuracy and/or reliability of the monitoring compared to methods in which the same threshold value is used for all portions of the toothing.

If multiple sensors are used to scan the toothing, the individual irregularities described above can result in a sensor signal in which long and short periods alternate regularly. Such a long-short pattern can particularly severely affect the measurement of the rotational speed of the gear if the periods of the long-short pattern are compared with the same reference period regardless of their corresponding lengths. Such non-uniformities can be effectively compensated for using the method.

For example, it can be detected that the gear is rotating too fast if the time value is less than the selected reference time value and/or rotating too slowly if the time value is greater than the selected reference time value.

In this case, a control command to stop the escalator can be generated in an additional step. Such a control command can cause a safety circuit of the escalator to be interrupted.

It may be useful if the sensor signal is scanned for rising flanks, at each of which a pulse begins. In this case, “time value” can be understood as a time interval between two adjacent rising flanks in the sensor signal. It can also be possible to scan for falling flanks, at each of which a pulse ends, or to scan for rising and falling flanks.

The gear can, for example, be a sprocket of a chain drive of the escalator. The chain drive can be designed to drive a step or pallet belt and/or a handrail of the escalator. In this case, the toothing of the sprocket can be connected to a drive pinion of the escalator via a drive chain when the escalator is in an operable state. In other words, the individual teeth of the sprocket can be used as a material measure for detecting the rotary movement. This can mean that an additional material measure may not be necessary, which makes the production of the escalator cheaper. However, it can also be possible to have a gear in the form of an additional measuring gear, which can rotate during operation of the escalator but may not transmit any drive forces itself.

For the sake of ease of reading, this disclosure uses only the terms “escalator and steps.” However, such terms should not be interpreted or construed as limiting the scope of the present disclosure, which can be used equally in moving walkways with pallets, for example.

A second aspect of the disclosure can relate to a signal processing device having a processor that can be configured to carry out the method described herein. The signal processing device may comprise hardware and/or software modules. In addition to the processor, the signal processing device may comprise a memory and a data communication interface for wireless and/or wired data communication with peripheral devices. The signal processing device can, for example, be part of an escalator control system of the escalator. However, it can also be designed as a unit that is physically separate from the escalator. Of course, it can also be possible that the signal processing device is implemented in a data cloud (cloud and cloud computing) and uses decentralized hardware of the Internet.

It should be noted that features of the method described herein may also be features of the signal processing device (and vice versa).

A third aspect of the disclosure can relate to a sensor device. The sensor device can comprise at least four sensors for scanning a toothing of a gear in the drive of an escalator at at least four scanning points, wherein each sensor can comprise an active surface and can be mounted such that the active surface may be opposite the toothing at the corresponding scanning point. Each of these sensors can be designed in such a way that it can emit an electrical pulse every time one of the teeth of the toothing passes the corresponding active surface. The sensor device can further comprise at least two outputs for connecting the sensor device to at least two inputs of a signal processing device (for example, the signal processing device described herein), wherein a first of the outputs can be connected to a first of the inputs via a first signal line, wherein a second of the outputs can be connected to a second of the inputs via a second signal line (separate from the first signal line), wherein at least two of the sensors can be connected to the first output for providing a first sensor signal and wherein at least two further sensors can be connected to the second output for providing a second sensor signal.

This can allow the use of a simpler and correspondingly cheaper signal processing device compared to sensor devices in which the output of each sensor is connected to a separate input of the signal processing device.

In addition, such a sensor device can enable a significantly more precise and/or reliable measurement compared to designs with fewer than four sensors, for example, with only two sensors or with only one sensor. This can also make it possible to verify the correct functioning of the escalator by comparing the signals from both measurement channels.

The term “sensor” as used herein may be understood to mean, for example, an inductive sensor, a Hall-effect sensor, an optical sensor or a combination of at least two of these examples.

The sensors of the sensor device can therefore be of the same type or of different types. If the sensors are inductive sensors, the inductive sensors can differ from each other, for example, in their oscillation frequency. This can prevent the sensors from interfering with each other during operation. The inductive sensors can also have the same oscillation frequency.

Preferably, the sensors can be mounted such that the active surfaces have different positions with respect to a circumferential direction of the gear.

The sensors can each be mounted using a special holder. Such a holder can be designed to enable precise alignment of the active surface of the corresponding sensor in three spatial directions, e.g., in the x-, y- and z-directions, relative to the toothing.

It should be noted that features of the methods described herein may also be features of the sensor device (and vice versa).

For example, the method described herein may further comprise: generating the first sensor signal and/or the second sensor signal by the sensor device described herein.

In other words, the first sensor signal provided at the first output of the sensor device and/or the second sensor signal provided at the second output of the sensor device may be suitable for being processed using the method described herein.

A fourth aspect of the disclosure can relate to an escalator. The escalator can comprise: a drive with a gear; at least one sensor for sensing a toothing of the gear at at least one scanning point, wherein the sensor can comprise an active surface and can be mounted such that the active surface is opposite the toothing at the scanning point, wherein the sensor can be designed to emit an electrical pulse each time one of the teeth of the toothing passes the active surface; and the signal processing device described herein.

As an alternative to at least one sensor, the escalator may comprise the sensor device described herein, wherein each sensor of the sensor device is mounted such that the active surface of the corresponding sensor is opposite the toothing at the corresponding scanning point.

It should be noted that features of the methods described herein may also be features of the escalator (and vice versa).

Further aspects of the disclosure can relate to a computer program and a computer-readable medium on which the computer program is stored.

The computer program can comprise commands which can cause a processor of a signal processing device to carry out the method described herein when the computer program is run by the processor.

The computer-readable medium can be a volatile or non-volatile data memory. For example, the computer-readable medium may be a hard disk, a USB storage device (universal serial bus), a RAM (random-access memory), a ROM (read-only memory), a PROM (programmable read-only memory), an EPROM (erasable programmable read-only memory), an EEPROM (electrically erasable programmable read-only memory), a flash memory or a combination of at least two of these examples. The computer-readable medium may also be a data communication network that allows program code to be downloaded (for example via the Internet), or a cloud.

It should be noted that features of the method described herein may also be features of the computer program and/or of the computer-readable medium (and vice versa).

Embodiments of the disclosure may be considered to be based on the concepts and findings described herein. These embodiments are not to be understood as limiting the scope of the disclosure.

According to one embodiment, the counting of the pulses can be started from the beginning when the count value of the last detected pulse matches a stop value that indicates a number of pulses within a pulse pattern repeating in the sensor signal.

The counting can be started again by resetting a counter for counting the pulses to a starting value, for example to “0” or “1.” The counting can then continue starting from the starting value, wherein the counter can be increased incrementally, for example, by the value “1,” with each detected pulse until the stop value is reached again. Counting can be carried out continuously while the escalator is in operation.

In other words, the set of possible count values that can be assigned to the detected pulses may not be indeterminate, but may be limited to certain count values. For example, the set of possible count values may include values for counting to four (e.g., “0, 1, 2, 3” or “1, 2, 3, 4”) if the repeating pulse pattern includes four consecutive pulses.

The repeating pulse pattern can be a known pulse pattern with a known number of pulses. The known pulse pattern can, for example, be a product of the configuration of a chain drive of the escalator containing the gear. It is also possible that the pulse pattern was determined in tests or in one or more separate learning runs before or parallel to the normal operation of the escalator.

In the simplest case, the stop value can be “2.” In this case, the repeating pulse pattern may consist of exactly two consecutive pulses. However, the stop value can also be significantly greater than “2.” For example, the stop value may be equal to a number of teeth on the gear (or an integer multiple thereof) and/or equal to a number of links on the drive chain (or an integer multiple thereof). In other words, the stop value may be equal to a number of pulses generated during one or more complete revolutions of the gear and/or drive chain in the same direction by scanning the sensor signal with the sensor or sensors.

It is possible that the pulse pattern changes during operation of the escalator, for example, due to temperature fluctuations or increasing wear. It can therefore be useful to automatically scan the sensor signal for repeating pulse patterns and determine a corresponding stop value from this.

Therefore, according to one embodiment, the method may further comprise a step of detecting a repeating pulse pattern by scanning the sensor signal. In this case, the pulses can be detected taking into account the detected pulse pattern. This can enable automatic detection of repeating pulse patterns in the sensor signal.

For this purpose, the sensor signal can be scanned for rising and/or falling flanks. Such detection can, for example, be carried out each time the escalator is started and/or during normal operation of the escalator (e.g., at regular intervals and/or when certain events are detected). The detection can take place, for example, during a learning run of the escalator, in which the gear is rotated by 360 degrees or by an integer multiple of 360 degrees in the same direction. Alternatively, the gear can also be rotated by less than 360 degrees during the learning run.

It is possible that multiple repeating pulse patterns can be detected by scanning the sensor signal. The detected pulse patterns can, for example, differ from one another in at least one of the following ways: the number of pulses, the time intervals between the pulses, and the total duration. Accordingly, a separate list of count values and reference time values can be generated for each detected pulse pattern. To evaluate the sensor signal, one of these lists can then be selected automatically, for example, depending on the current operating conditions of the escalator. It is therefore possible to switch between the different lists multiple times during operation of the escalator. It can also be conceivable that the sensor signal can be evaluated simultaneously using multiple such lists. In this way, a certain degree of redundancy can be created, which may improve the reliability of the method.

According to one embodiment, the stop value may constitute a number of pulses within the detected pulse pattern. In other words, when the pulse pattern is detected, it can be possible to determine, among other things, how many pulses the pulse pattern consists of and to set a corresponding stop value (for example, with four pulses, a stop value of “4” for a count from “1” to “4” or a stop value of “3” for a count from “0” to “3”). This may allow the stop value to be updated automatically when a new pulse pattern is detected, for example, due to temperature fluctuations and/or increasing wear.

According to one embodiment, detecting the pulse pattern may include: counting the pulses within the pulse pattern by assigning a count value to each pulse; determining a time value for each pulse within the pulse pattern, wherein the time value indicates a time interval between the pulse and the next pulse. The method may further comprise: determining a reference time value for each count value that was assigned to a pulse when the pulse pattern was detected, by multiplying the time value of the corresponding pulse by a factor; storing the reference time values together with the corresponding count values in the list.

In other words, a set of possible count values, which can later be used to count the pulses, and the associated reference time values can be determined from the sensor signal. For example, if the count values “1, 2, 3, 4” (or “0, 1, 2, 3”) were assigned one after the other when the pulse pattern was detected, the count may proceed until the count value “4” (or “3”) is reached after the pulses are detected-before the counting starts again from the beginning, e.g., at “1” (or “0”). In other words, each count can end after the fourth pulse, e.g., the stop value is “4” (or “3”) and corresponds to the number of pulses within the detected pulse sequence. For each of the above-mentioned count values, a specific reference time value can be stored in the list. The above steps can be performed during a learning phase outside the normal operation of the escalator and/or parallel to the normal operation of the escalator.

This may allow the reference time values to be updated automatically when a new pulse pattern is detected, for example, due to temperature fluctuations and/or increasing wear.

In addition, the detected pulse pattern can be used to identify properties of the corresponding chain drive of the escalator, for example, to determine whether the escalator is equipped with the correct chain drive.

The factor can, for example, be between 0.80 and 0.95, preferably 0.90.

According to one embodiment, the method may further comprise a step of determining whether the detected pulse pattern is plausible by comparing a total duration of the detected pulse pattern with a reference duration. The detected pulse pattern may be retained if it is plausible and/or discarded if it is not plausible.

For example, the sensor signal may be re-scanned in response to discarding the pulse pattern, to detect a repeating pulse pattern.

The total duration of the detected pulse pattern can be measured and/or calculated. Preferably, the total duration can be determined by adding the time values of the pulses within the detected pulse pattern.

The reference duration can, for example, be a quotient of a distance traveled by the gear during the total duration of the detected pulse pattern (e.g., if the pulses are counted until the corresponding stop value is reached) and the desired speed of the gear, or can be determined depending on this quotient.

For example, the detected pulse pattern may be classified as implausible if the total duration is outside a certain tolerance range (e.g., plus/minus 1%, plus/minus 5% or plus/minus 10%) around the reference duration.

According to one embodiment, the sensor signal may have been generated using at least two sensors for scanning the toothing at different scanning points, in particular by superimposing output signals of the at least two sensors over the same period of time. In this way, the accuracy of the method can be significantly increased compared to versions with only one sensor. Preferably, the sensor signal may have been generated in such a way that the pulses in the sensor signal do not overlap in time. This may allow a clear determination of the number and length of the pulses.

According to one embodiment, the sensor signal (generated using the at least two sensors) can be a first sensor signal; furthermore, a second sensor signal, which may have been generated using at least two further sensors, in particular by superimposing output signals of the at least two further sensors over the same period of time, can be received by the signal processing device. Both sensor signals may have been generated in such a way that each pulse in the first sensor signal may partially overlap in time with a pulse in the second sensor signal. Accordingly, the method may further comprise: determining a current direction of rotation of the gear by evaluating the first sensor signal together with the second sensor signal, and/or using the second sensor signal to detect whether the gear is rotating at the desired speed.

The direction of rotation can be determined, for example, based on a characteristic sequence of rising and/or falling flanks of pulses in a superposition of the two sensor signals over the same period of time—or, in other words, based on a characteristic sequence of overlapping pulses of the two sensor signals.

If the current direction of rotation deviates from a desired direction of rotation, a control command to stop the escalator can be generated in an additional step.

When the second sensor signal is used for speed monitoring, the second sensor signal can be processed in the same or similar manner as the (first) sensor signal. For example, the two sensor signals can be processed in parallel for this purpose, thus creating a certain degree of redundancy. This can have the advantage that the speed monitoring still functions with sufficient accuracy even if one of the two sensor signals fails or is disturbed for any reason.

According to one embodiment, the sensors of the sensor device can be mounted such that the active surfaces have the same position with respect to an axial direction of the gear. For example, the active surfaces can be located one behind the other in the circumferential direction of the gear. The active surfaces can also partially overlap in the circumferential direction of the gear. Such a linear arrangement of the active surfaces can be advantageous for reasons of space.

Alternatively, the sensors can be mounted such that at least two of the active surfaces each have a first position and at least two further active surfaces each have a second position different from the first position with respect to an axial direction of the gear.

If the gear is a duplex gear with a first toothing and a second toothing, the teeth of which are aligned with the teeth of the first toothing in the axial direction of the gear, then, for example, the active surfaces of the first toothing in the first position and the active surfaces of the second toothing in the second position can be opposite each other.

It is possible that the sensors whose active surfaces each have the first position are connected to the first output of the sensor device, while the sensors whose active surfaces each have the second position are connected to the second output of the sensor device.

Alternatively, the sensors whose active surfaces have different positions with respect to the axial direction can be connected to the same output.

According to one embodiment, the first positions can be offset from each other in the circumferential direction of the gear by more than one whole tooth pitch (p) of the gear.

According to one embodiment, the second positions can be offset from each other in the circumferential direction of the gear by more than one whole tooth pitch (p) of the gear.

The corresponding offset can, for example, be at least 1.01p, at least 1.1p or at least 1.5p. In addition, the corresponding offset can be less than twice the entire tooth pitch, for example a maximum of 1.99p, a maximum of 1.9p or a maximum of 1.6p. This can have the effect that the pulses of the corresponding sensors (which can, for example, be connected to the same output) do not overlap in time. This can allow a clear determination of the number and length of the pulses.

According to one embodiment, the first positions in the circumferential direction of the gear can have the same distance from each other as the second positions.

According to one embodiment, each first position can be offset from one of the second positions in the circumferential direction of the gear by less than a whole tooth pitch (p) of the gear, in particular by less than half a tooth pitch of the gear. The offset may, for example, be 0.99p or less, 0.9p or less, in particular 0.49p or less or 0.4p or less. In tests, an offset between 1 mm and 5 mm, especially 3 mm, proved to be particularly favorable. This can have the effect that the pulses of a sensor, whose active surface has the first position, partially overlap in time with the pulses of a sensor whose active surface has the second position, which is offset from the first position. This can make it possible, for example, to detect the current direction of rotation of the gear (see also herein).

By arranging the active surfaces in pairs in this way, some of the problems that occurred with the aforementioned linear arrangement could be largely avoided.

### BRIEF DESCRIPTION OF THE DRAWINGS

Embodiments of the disclosure will be described below with reference to the accompanying drawings. Neither the description nor the drawings are to be understood as limiting the scope of the disclosure.

FIG. 1 is an escalator according to one embodiment of the disclosure.

FIG. 2 is a sensor device according to one embodiment of the disclosure.

FIG. 3 is a sensor device according to an alternative embodiment of the disclosure.

FIG. 4 shows portions of sensor signals as processed in a method according to an embodiment of the disclosure.

The drawings are purely schematic and are not to scale. Where the same reference signs are used in different drawings, these reference signs denote identical or equivalent features.

### DETAILED DESCRIPTION

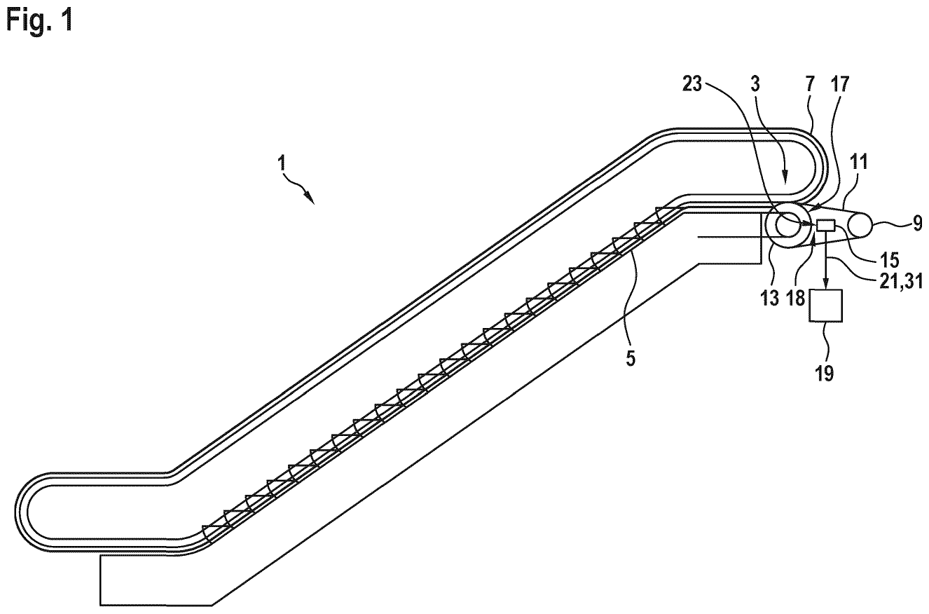

FIG. 1 is an escalator 1 with a chain drive 3 for driving a step belt 5 and a handrail 7 of the escalator 1. The chain drive 3 comprises a drive pinion 9, which is connected via a drive chain 11 to a gear 13 in the form of a sprocket. The gear 13 can be a main drive gear which is connected via a shaft to a first drive gear for driving the step belt 5 and to a second drive gear for driving the handrail 7. The drive pinion 9 can be driven by an electric motor. A transmission can be arranged between the drive pinion 9 and the electric motor to transmit rotary movement and torque.

In addition, the escalator 1 comprises a sensor 15 for scanning a toothing 17 of the gear 13 at a scanning point 18 and a signal processing device 19 for processing a sensor signal 21 which may have been generated using the sensor 15. The sensor 15 can be, for example, an inductive sensor, a Hall-effect sensor, an optical sensor or a combination of at least two of these sensor examples. The sensor 15 is arranged such that its active surface 23 is opposite the toothing 17 at the scanning point 18 at a certain distance. Each time one of the teeth of the toothing 17 passes the active surface 23, the sensor 15 can generate an electrical pulse 25 (see FIG. 4). The sensor signal 21 can be an output signal of the sensor 15. Alternatively, the sensor signal 21 may be based on the output signal.

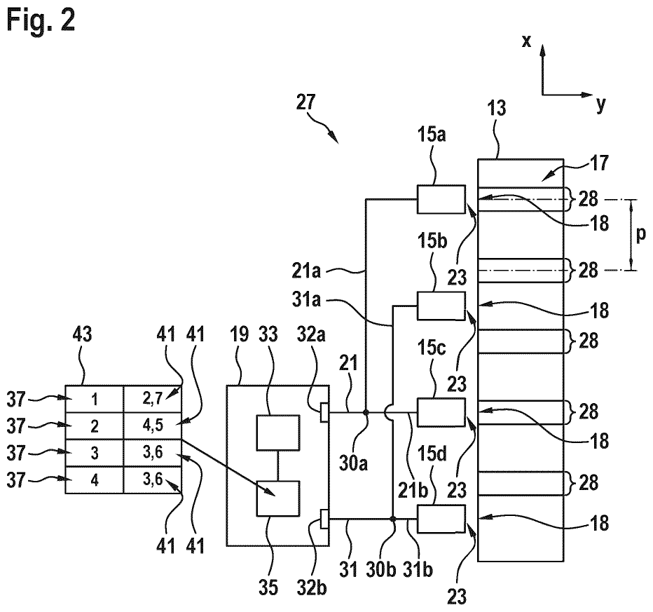

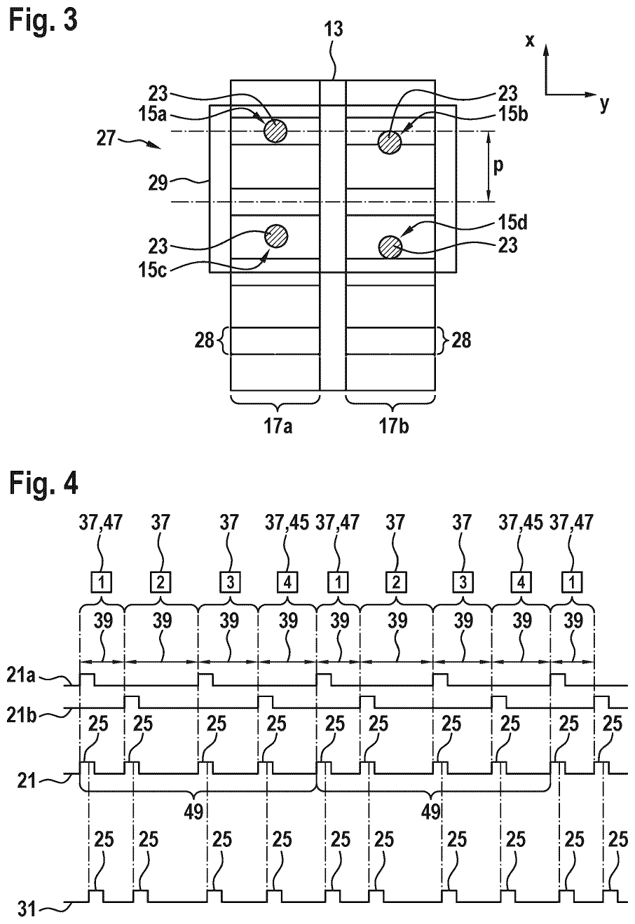

As shown in FIG. 2 and FIG. 3, the escalator 1 can alternatively comprise a sensor device 27 with a plurality of sensors for scanning the toothing 17 at a plurality of scanning points 18—in this case with a first sensor 15a, a second sensor 15b, a third sensor 15c and a fourth sensor 15d (FIG. 2 and FIG. 3 each show a toothed portion of the gear 13 in plan view, wherein the head surfaces 28 of the individual teeth are oriented toward the plane of the drawing).

As shown in FIG. 2, the four sensors 15a, 15b, 15c, 15d can, for example, be mounted such that their active surfaces 23 are opposite the same side of the toothing 17—in this case, one of the lateral flanks of the toothing 17. The active surfaces 23 can have substantially the same position with respect to an axial direction y of the gear 13 and can be located one behind the other at a certain distance in the circumferential direction x of the gear 13.

The distance in the x-direction between adjacent active surfaces 23 can be greater in this case than a whole tooth pitch p and can be less than twice the tooth pitch p. An arrangement in which the distance is greater than 2p or less than p, for example, less than 0.5p, in particular less than 0.25p, can also be conceivable.

The sensors 15a, 15b, 15c, 15d are arranged in this case such that—viewed in the x-direction—the active surface 23 of the sensor 15b lies between the active surfaces 23 of the sensors 15a, 15c and the active surface 23 of the sensor 15c lies between the active surfaces 23 of the sensors 15b, 15d.

FIG. 3 is a variant in which the gear 13 is designed as a duplex gear with a first toothing 17a and a second toothing 17b, wherein the teeth of the first toothing 17a are aligned with the teeth of the second toothing 17b in the y-direction (axially). The two toothings 17a, 17b can correspond to each other in their geometric properties. In this example, the active surfaces 23 of the sensors 15a, 15c are opposite a side of the first toothing 17a having the head surfaces 28, while the active surfaces 23 of the sensors 15b, 15d are opposite a side of the second toothing 17b having the head surfaces 28.

Alternatively, the active surfaces 23 opposite the first toothing 17a may be those of the sensors 15a, 15b and the active surfaces 23 opposite the second toothing 17b may be those of the sensors 15c, 15d.

The active surfaces 23 can also be opposite a lateral flank of the corresponding toothing 17a or 17b.

As can be seen in FIG. 3, the active surfaces 23 opposite the first toothing 17a each have a first position in the y-direction. The active surfaces 23 opposite the second toothing 17b, however, each have a second position in the y-direction that is different from the first position.

The first positions in the x-direction can have the same distance from each other as the second positions. However, the distances can also differ from each other.

In addition, in this example, every second position in the x-direction is offset by less than half a tooth pitch p from one of the first positions. The offset can preferably be between 1 mm and 5 mm. In tests with common gear types, an offset of 3 mm proved to be particularly suitable for obtaining easily analyzable sensor signals.

The four sensors 15a, 15b, 15c, 15d can, for example, be mounted on the same plate 29 as the holder, in particular screwed into it, wherein the plate 29 can be adjustable at least in the x and y directions relative to the gear 13. For example, a radial distance (relative to an axis of rotation of the gear 13, not shown) of each active surface 23 to the toothing 17a or 17b can be adjusted by screwing the corresponding sensor 15a, 15b, 15c or 15d into the plate 29 either more deeply or less deeply. Alternatively or additionally, the plate 29 as a whole can be radially adjustable.

As shown schematically in FIG. 2, it is possible that two of the four sensors 15a, 15b, 15c, 15d are combined to form one measurement channel.

In the examples shown in FIG. 2 and FIG. 3, the first sensor 15a and the third sensor 15c are connected to a first output 30a of the sensor device 27 to form a first measurement channel for providing a first sensor signal 21, wherein the second sensor 15b and the fourth sensor 15d are connected to a separate second output 30b of the sensor device 27 to form a second measurement channel for providing a second sensor signal 31. The first output 30a is connected to a first input 32a of the signal processing device 19 via a first signal line. The second output 30b is connected to a second input 32b of the signal processing device 19 via a separate second signal line.

Accordingly, the sensor signal 21 or 31 can be a superposition of the output signals of different sensors of the same measurement channel over the same period of time—in this case, a first output signal 21a or 31a with a second output signal 21b or 31b (see also FIG. 4).

Alternatively, each sensor 15a, 15b, 15c, 15d can be connected at its output to its own input of the signal processing device 19. In this case there are four measurement channels.

As shown in FIG. 2, the signal processing device 19 may comprise a processor 33 and a memory 35 in which a special computer program is stored. The processor 33 may be configured to perform a method for monitoring a rotary movement of the gear 13 by executing the computer program, as described in more detail below.

In a first step, the sensor signal 21 may be received in the signal processing device 19.

In a second step, the sensor signal 21 may be scanned to detect pulses 25 (see FIG. 4). For this purpose, the first sensor signal 21 can be scanned, for example, for rising flanks. The detected pulses 25 may be counted by assigning a count value 37 to each pulse 25, or more precisely to each period comprising a pulse 25, wherein the count value 37 may be increased each time a new pulse 25 is detected (in this case, by 1). In addition, for each detected pulse 25, a time value 39 may be determined, which can indicate a time interval between the pulse 25 and the next pulse, e.g., a duration of the corresponding period.

The count value 37 and the time value 39 of each detected pulse 25 may then be processed as follows.

First, a reference time value 41 (see FIG. 2) may be determined by comparing the count value 37 with a list 43 which assigns a reference time value 41 to each count value 37. The list 43 can be stored in the memory 35.

Next, a deviation of the time value 39 from the selected reference time value 41 may be determined.

The deviation may finally be used to determine whether the gear 13 is rotating at a desired speed. For example, it may be detected that the gear 13 is rotating too fast if the time value 39 is less than the selected reference time value 41, or that it is rotating too slowly if the time value 39 is greater than the selected reference time value 41.

If the gear 13 is rotating too quickly, the signal processing device 19 may generate a control command in an additional step which may cause the escalator 1 to be transferred to a safe state. This may be achieved by interrupting a safety circuit of the escalator 1, thereby stopping the escalator 1.

The counting of pulses 25 can be continued until the count value 37 of the last counted pulse 25 matches a predefined stop value 45. The counting may then start again from the beginning at a predefined starting value 47 (in this case, at “1”).

The stop value 45 can indicate after how many consecutive pulses 25 a certain pulse pattern 49 in the sensor signal 21 may be repeated. In this example, the pulse pattern 49 includes four consecutive pulses 25. The stop value 45 can therefore be “4.”

The pulse pattern 49 can be detected, for example, by evaluating the sensor signal 21. Alternatively, the pulse pattern 49 may be a known pulse pattern—which may be known, among other things, from the geometric properties of the gear 13 or the chain drive 3. Sensor-based detection of the pulse pattern 49 may therefore not be absolutely necessary.

The detection of the pulse pattern 49 may include the following steps.

The pulses 25 within the detected pulse pattern 49 may be counted by assigning a count value 37 to each pulse 25. The count value 37 (here “4”) of the last pulse 25 may be stored as stop value 45.

In addition, a time value 39 may be determined for each pulse 25 within the detected pulse pattern 49.

In addition, a reference time value 41 may be determined for each count value 37 that has been assigned to one of the pulses 25 of the detected pulse pattern 49, for example, by multiplying the time value 39 of the corresponding pulse 25 by a certain factor (here by 0.90).

The resulting reference time values 41 can then be stored together with the corresponding count values 37 in the list 43.

In addition, it can be determined whether the detected pulse pattern 49 is plausible by comparing its total duration, e.g., the sum of all time values 39 related to the pulse pattern 49, with a reference duration.

The reference duration may have been determined experimentally and/or calculated, for example by dividing a distance corresponding to the number of pulses 25 within the pulse pattern 49 by the desired speed of the gear 13. The pulse pattern 49 may be used if it is plausible. Otherwise, the pulse pattern 49 may be discarded. The sensor signal 21 can then, for example, be sampled again to detect a pulse pattern 49. Such a learning phase can last at least until a repeating pulse pattern is detected with sufficient accuracy.

By repeatedly performing the aforementioned steps to detect the pulse pattern 49, for example, at each start and/or during normal operation of the escalator 1, the list 43 can be kept up to date.

It is also possible to switch between different lists 43, which can be based on different known and/or sensor-detected pulse patterns in the sensor signal 21, for example, if unusual deviations are detected when using one of the lists 43. The number of entries in each list 43 (e.g., the number of value pairs consisting of a count value 37 and a reference time value 41) can correspond to the number of periods within the corresponding pulse pattern. In the simplest case, the number of periods can be equal to two. However, the number of periods can also be, for example, equal to the number of teeth on the gear 13 (or an integer multiple thereof) or equal to a product of the number of teeth on the gear 13 and the number of chain links on the drive chain 11 and/or another chain on the chain drive 3 (or an integer multiple thereof).

Such a method can offer the possibility of a precise measurement of excessive speed with the shortest possible response time, even if the sensor signal 21 is highly non-uniform. Each individual pulse 25 can be used for the measurement of excessive speed—e.g., after each individual pulse 25, a decision can be made as to whether the escalator 1 should be stopped or not. Unintended shutdowns of the escalator 1 due to unevenly distributed pulses 25 within a pulse pattern 49 can thus be avoided by the present method.

The speed monitoring steps described herein using the example of the (first) sensor signal 21 can additionally be carried out in the same (or similar) manner using the second sensor signal 31.

The special arrangement of the active surfaces 23 shown in FIG. 3 can have the effect that both sensor signals 21, 31 are generated in such a way that each pulse 25 in the first sensor signal 21 partially overlaps in time with a pulse 25 in the second sensor signal 31 (see FIG. 4). This can mean that between the two flanks of each pulse 25 of the first sensor signal 21 there is exactly one rising flank of the second sensor signal 31 when the gear 13 rotates in one direction, or exactly one falling flank of the second sensor signal 31 when the gear 13 rotates in the other direction. This circumstance can be used to detect in an additional step whether the gear 13 is rotating in a desired direction. If the gear 13 is not rotating in the desired direction, a control command to bring the escalator 1 into a safe state can be generated in an additional step—as in the speed monitoring.

Finally, it should be noted that terms such as “having,” “comprising,” “including,” “with,” etc. do not exclude other elements or steps, and indefinite articles such as “a” or “an” do not exclude a plurality. Furthermore, it should be noted that features or steps that are described with reference to one of the above embodiments may also be used in combination with features or steps that are described with reference to other of the above embodiments. Reference signs in the claims are not to be understood as limiting the scope of the subject matter defined by the claims.

1-15. (canceled)

16. A method for monitoring a rotary movement of a gear in a drive of an escalator, the method comprising:
receiving a sensor signal generated using at least one sensor for scanning a toothing of the gear in a signal processing device;
detecting pulses by scanning the sensor signal;
counting the pulses by assigning a count value to each pulse;
assigning each pulse a time value which indicates a time interval between the pulse and a next pulse; and
for each pulse detected:
selecting a reference time value by comparing the count value associated with the pulse detected with a list that assigns reference time values to possible count values;
determining a deviation of the time value associated with the pulse detected from the reference time value selected; and
detecting from the deviation whether the gear is rotating at a desired speed.

17. The method of claim 16, wherein counting the pulses is restarted if the count value of a last detected pulse corresponds to a stop value, wherein the stop value indicates a number of pulses within a pulse pattern repeating in the sensor signal.

18. The method of claim 17, further comprising:
detecting a repeating pulse pattern by sampling the sensor signal, wherein the pulses are detected taking into account the repeating pulse pattern detected.

19. The method of claim 18, wherein the stop value indicates a number of pulses within the repeating pulse pattern detected.

20. The method of claim 18, wherein detecting the repeating pulse pattern comprises:
counting the pulses within the repeating pulse pattern by assigning a count value to each pulse; and
determining a time value for each pulse within the repeating pulse pattern, the time value indicating a time interval between the pulse and the next pulse,
wherein the method further comprises:
determining a reference time value for each count value that was assigned to a pulse upon detection of the repeating pulse pattern by multiplying the time value of the corresponding pulse by a factor; and
saving the reference time values together with the corresponding count values in the list.

21. The method of claim 18, further comprising:
determining whether the repeating pulse pattern detected is plausible by comparing a total duration of the repeating pulse pattern detected with a reference duration; and
retaining the repeating pulse pattern detected if it is plausible.

22. The method of claim 21, further comprising discarding the repeating pulse pattern detected if it is not plausible.

23. The method of claim 16, wherein the sensor signal was generated using at least two sensors for scanning the toothing at different scanning points by superimposing output signals of the at least two sensors over the same period of time.

24. The method of claim 23,
wherein the sensor signal, which is a first sensor signal generated using the at least two sensors, and a second sensor signal, which was generated using at least two further sensors for scanning the toothing at different scanning points by superimposing output signals of the at least two further sensors over the same period of time, are received by the signal processing device,
and wherein the first sensor signal and the second sensor signal were generated such that each pulse in the first sensor signal partially overlaps in time with a pulse in the second sensor signal,
and wherein the method further comprises:
determining a current direction of rotation of the gear by evaluating the first sensor signal together with the second sensor signal; and/or
using the second sensor signal to detect whether the gear is rotating at the desired speed.

25. A signal processing device comprising a processor configured to carry out the method of claim 16.

26. A sensor device, comprising:
at least four sensors configured to scan a toothing of a gear in a drive of an escalator on at least four scanning points, each sensor of the at least four sensors comprising an active surface and configured to mount such that the active surface is opposite the toothing at the corresponding scanning point, and wherein each sensor of the at least four sensors is configured to emit an electrical pulse each time a tooth of the toothing passes the corresponding active surface; and
at least two outputs configured to connect a sensor device to at least two inputs of a signal processing device, wherein a first output of the at least two outputs is connected to a first input of the at least two inputs via a first signal line, and wherein a second output of the at least two outputs is connected to a second input of the at least two inputs via a second signal line, and wherein at least two sensors of the at least four sensors are connected to the first output and configured to provide a first sensor signal, and wherein at least two further sensors of the at least four sensors are connected to the second output and configured to provide a second sensor signal.

27. The sensor device of claim 26, wherein the at least four sensors are mounted such that the active surfaces have the same position with respect to an axial direction of the gear; or wherein the at least four sensors are mounted such that at least two of the active surfaces each have a first position, and at least two further active surfaces each have a second position different from the first position with respect to an axial direction of the gear.

28. The sensor device of claim 27, wherein the first positions are offset from one another in a circumferential direction of the gear by more than one whole tooth pitch of the gear.

29. The sensor device of claim 27, wherein the second positions are offset from one another in a circumferential direction of the gear by more than one whole tooth pitch of the gear.

30. The sensor device of claim 27, wherein the first positions have the same distance from each other in a circumferential direction of the gear as the second positions.

31. The sensor device of claim 27, wherein each first position is offset from one of the second positions in a circumferential direction of the gear by less than a whole tooth pitch of the gear, in particular by less than half a tooth pitch of the gear.

32. An escalator or moving walkway, comprising:
a drive with a gear;
at least one sensor for scanning a toothing of the gear on at least one scanning point, wherein the at least one sensor comprises an active surface and is mounted such that the active surface is opposite the toothing at the scanning point, wherein the at least one sensor is configured to emit an electrical pulse each time one tooth of the toothing passes the active surface; and
the signal processing device of claim 25.
